(19) United States
(12) Patent Application Publication
(10) Pub. No.: US 2012/0240894 A1
(43) Pub. Date: Sep. 27, 2012

(54) DEVICE FOR TRANSMISSION OF FORCE FROM THE PISTONS OF A PISTON ENGINE

(76) Inventor: Odd Bernhard Torkildsen, Oslo (NO)

(21) Appl. No.: 13/514,368

(22) PCT Filed: Nov. 18, 2010
(86) PCT No.: PCT/NO2010/000420

§ 371 Date: Jun. 7, 2012

(30) Foreign Application Priority Data
Nov. 18, 2010 (NO) PCT/NO2010/000420

(51) Int. Cl. F02B 75/32

(52) U.S. Cl. 123/197.1

(57) ABSTRACT

Device for transmission of force from the pistons of a piston engine, where the pistons (3, 4) of two opposite combustion cylinders cooperate with alternating power strokes, the common piston rods (3, 4) of the cylinders being supported on a balance arm (6) at a distance from the bearing (14) of the balance arm (6) to perform a rocking movement around the bearing (14), where the piston rods of two further opposite and cooperating combustion cylinders (17, 18) being supported on the balance arm (6) opposite and at a distance from the bearing (14), and the balance arm (6) being connected with a flywheel (8), where the bearings (16, 26) on the balance arm (69 between the bearings (14 of the balance arm (6) and the bearings (15, 27) of the piston rods (5, 19) on the balance arm (6) being directly connected with a shaft for energy transforming means.

The present invention is related to a device for transmission of force from the pistons of a piston engine, according to the preamble of the claims.

Transmission of force from the pistons of a piston combustion engine normally is made by the piston rods of the cylinders to a crankshaft. The transmission to the crankshaft is dependent on the angle of the crank arm in relation to the movement of the piston, thereby transforming the linear movement to the rotation of the crankshaft.

With the device for transmission of the force from the pistons of a piston engine according to the present invention the piston force is transformed substantially from the moment of ignition. This is obtained with the device according to the present invention as defined by the features stated in the claims.

Devices within this technical field are known i.a. from U.S. Pat. No. 4,516,539 and U.S. Pat. No. 2,384,401.

With the device according to the invention the force from the pistons may be utilized mechanically, electrically, pneumatically or hydraulically.

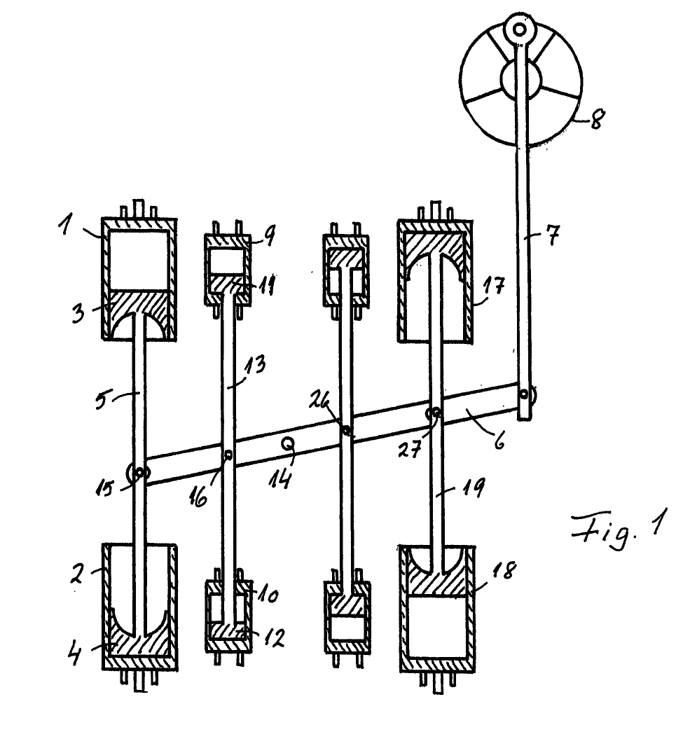

FIG. 1 of the drawing discloses a principal sketch of one embodiment of the device for transforming the kinetic energy of the pistons to hydraulic energy, and

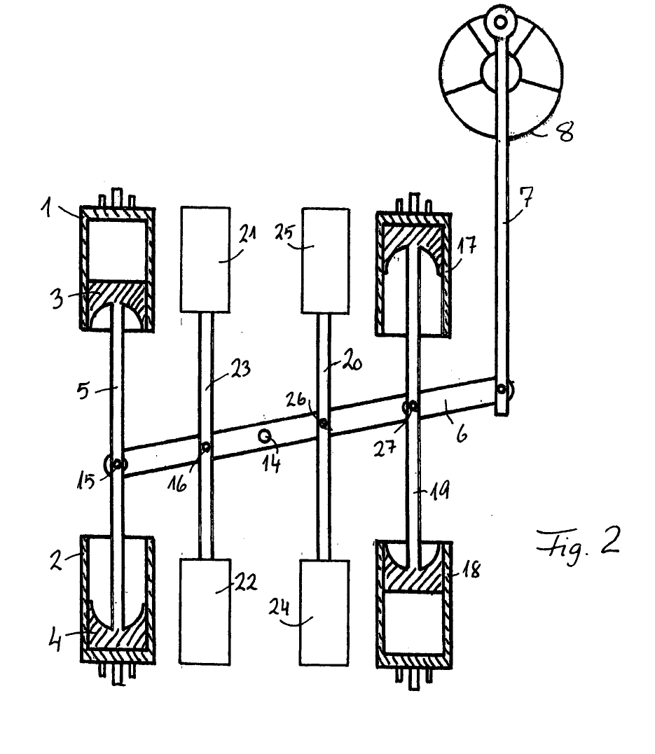

FIG. 2 discloses a principal sketch of a device transforming the energy to electric energy.

According to the invention two opposite cylinders 3 and 4 are connected by a common piston rod 5 being connected to a balance arm 6 in a bearing 5. The common piston rod 5 possibly may be split having bearings in the pistons and in the balance arm as well. Said balance arm 6 is connected with an arm 7 operating a flywheel 8 securing continous operation of the pistons. Each combustion cylinder 1, 2 comprises as well known valves for supply of fuel and air and for exhaust gas as well as an ignition mechanism.

The balance arm 6 is supported on a shaft 14 at a distance from the bearing 15 of the piston rod 5, thereby carrying out a rocking movement in one direction by ignition of the fuel in one cylinder 1 and a return movement by ignition of the fuel in the opposite cylinder 2. The cylinders 1, 2 may operate according to the two-cycle or the four-cycle principle. Further opposite cylinders 17, 18 having a common piston rod 19 being supported in a bearing 27 on the balance arm 6 at a distance corresponding from the shaft 14 of the balance arm on the opposite side of the shaft 14.

The piston rods 5, 19 may be through going and supported in slide bearings in the bearings 15, 27 on the balance arm 6 to assume the movements of same or the piston rods 5, 19 may be split and supported in bearings 15, 27 on the balance arm 6 and in the pistons.

The balance arm 6 is connected with energy transforming means for transfer of mechanical, hydraulic, electric or pneumatic energy to be utilized.

For mechanical utilization of the energy the rotation energy of the flywheel 8 may be used or a separate flywheel may be connected with the balance arm 6 in another way to transform the rocking movement to rotary energy.

For transfer of the energy to hydraulic energy two opposite hydraulic cylinders 9 and 10 may have pistons 11 and 12 with a common piston rod 13 supported in a bearing 16 on the balance arm 6 between the bearing 15 for the piston rod 5 of the combustion cylinders and the shaft 14, as disclosed in FIG. 1. The piston rod 13 may be in one piece or being split having a piston rod from the balance arm 6 to each cylinder 9 and 10. The hydraulic cylinders 9, 10 comprise valves for pressurized hydraulic oil and for non pressurized hydraulic oil. Correspondingly the hydraulic cylinders comprise a common piston rod being supported in a bearing 26 on the balance arm at a distance from the bearing 14 of the bearing arm corresponding with the bearing 16 of the first piston rod 13 on the other side of the bearing 14 of the balance arm.

For transferring the energy to electric energy an arm 20, 23 on each side of the shaft 14 of the balance arm may be connected with the balance arm 6 for operation of generators 21, 22, 24 and 25, as disclosed in FIG. 2.

1. Device for transmission of force from the pistons of a piston engine, where the pistons (3, 4) of two opposite combustion cylinders cooperate with alternating power strokes, the common piston rods (3, 4) of the cylinders being supported on a balance arm (6) at a distance from the bearing (14) of the balance arm (6) to perform a rocking movement around the bearing (14), where the piston rods of two further opposite and cooperating combustion cylinders (17, 18) being supported on the balance arm (6) opposite and at a distance from the bearing (14), and the balance arm (6) being connected with a flywheel (8), characterized in that bearings (16, 26) on the balance arm (69 between the bearings (14 of the balance arm (6) and the bearings (15, 27) of the piston rods (5, 19) on the balance arm (6) being directly connected with a shaft for energy transforming means.

2. Device according to claim 1, characterized in that the energy transforming means being piston rods (13) for providing hydraulic pressure in cylinders with pistons (11, 12).

3. Device according to claim 1, characterized in that the energy transforming means being arms (20, 23) connected with the balance arm (6) of each side of the bearing (14) of the balance arm (6), operating generators (21, 22, 24, 25).
